(19) United States
(12) Patent Application Publication
(10) Pub. No.: US 2006/0036783 A1
(43) Pub. Date: Feb. 16, 2006

(54) Method and apparatus for content presentation

(75) Inventor: Ronaldus Maria Aarts, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS EPECTRONICS, N.V., EINDHOVEN (NL)

(21) Appl. No.: 10/527,116

(22) PCT Filed: Aug. 6, 2003
(86) PCT No.: PCT/IB03/03515

§ 371 Date: Mar. 8, 2005

(30) Foreign Application Priority Data
Sep. 13, 2002 (EP) 02078781.8

(51) Int. Cl. G06F 13/14

(52) U.S. Cl. 710/58

(57) ABSTRACT

The invention relates to a system for content presentation of content signals such as video signals. A content presentation apparatus comprises a content signal receiver (201) receiving a content signal from a content source (203). The signal is stored in a memory (205). The memory is connected to a content analyser (207) which analyses the content and determines to which category of content this belongs. The apparatus further comprises a user preference profile processor (211) which determines a preferred presentation rate for different categories of content in response to a user input or a previous user behaviour. A playback controller (213) controls the playback of the content by setting the presentation rate to the preferred presentation rate of the user preference profile for the content category identified. Specifically, the invention provides for e.g. a fast forward button which fast forwards through unwanted content but plays at normal rate during user preferred content.

### FIELD OF THE INVENTION

The invention relates to a method and apparatus for content presentation and specifically for content presentation of video or multimedia signals.

### BACKGROUND OF THE INVENTION

In recent years, variation and diversity in content provision has increased significantly and consumers are currently provided with information and services of a previously unheard quantity. Such developments include for example the explosion in the quantity of TV broadcast content available from an ever increasing number of TV channels, the increased availability of fact based information such as news, sports results or stock market information, and not least the increased availability of multimedia content from all sources including specifically the Internet.

Hence, it has become increasingly important for a user to filter the available content and especially to quickly identify content of specific interest and relevance to the individual user.

For example, video broadcasting for entertainment and consumer applications have increased significantly. It is now common in most countries that a viewer has the opportunity of watching TV programmes from a large number of terrestrial and satellite TV channels having a varied content. In addition, the content of the individual channels or even the individual programmes has become increasingly varied. For example, a TV channel typically does not only comprise TV programmes but also comprises advertising, previews, station identification clips, public information clips, news flashes etc. Further, the content of programmes often range widely and even an individual programme may have a wide range of content, Some content may be directed to target groups of viewers but of little interest to or directly unsuitable for other categories.

In addition, the technology associated with content provision such as video broadcasting and recording is rapidly advancing and especially the use of digital video compression has led to increased facilities, controllability and user friendliness being provided.

As a specific example, US-A-2001/0013949 discloses a system wherein a broadcaster includes separate playback rate signal with the broadcast. The separate playback rate signal includes information of the playback rate that should be used by the video receiver for the currently received broadcast signal. However, the method of US-A-2001/0013949 discloses that a separate playback rate signal is broadcast together with the video signal. It is therefore required that a receiver has complex circuitry required for decoding and controlling playback rates accordingly. In addition, the system only provides for the broadcasting end to control the playback rate and does not provide increased control and flexibility for the user.

### SUMMARY OF THE INVENTION

Accordingly, the Invention seeks to provide an improved system for control of content presentation.

Accordingly, there is provided in a first aspect of the invention, a method of content presentation comprising: receiving a content signal from a content source; deriving a content indicator from a content analysis of the content signal; and adjusting a presentation rate of the content signal in response to the content indicator. This provides for a method of controlling the presentation rate in response to the content. Thus unwanted content may for example be forwarded through whereas appropriate content is presented at a slower or real time rate. Hence, the invention may thus provide an improved method for presenting content wherein desired content can be automatically presented at a different rate than less preferred content. Thereby an increased flexibility and customisation of content presentation to one or more users may be achieved. Further, the presentation rate is set in response to the content of the signals and there is thus no requirement for a separate presentation rate signal to be included with the content signal.

According to an embodiment of the invention, the step of adjusting further comprises adjusting the presentation rate in response to a user preference profile. Hence, this provides for the presentation rate of different content to be specifically adapted and customised to the preferences of one or more user.

According to another embodiment of the invention, the user preference profile is determined in response to a previous user behaviour. This provides the advantage that the presentation of content may automatically be adapted to the preferences and behaviour of one or more users.

According to a different embodiment of the invention, the user preference profile is determined in response to a user input. This provides the advantage of the user having control over the presentation of content.

According to one embodiment of the invention, the step of adjusting the presentation rate comprises selection between a first presentation rate and at least a second presentation rate. Hence, a simple low complexity implementation is possible while still providing a suitable variation in the presentation of different content.

According to another embodiment of the invention, the first presentation rate is a fast forward rate and the second presentation rate is a substantially real time presentation rate. This allows for fast forwarding through unwanted content and real time presentation of desired content. Hence, it provides the advantage of being a method for fast and convenient automatic presentation of desired content while reducing time for undesired content.

According to a different embodiment of the invention, at least one presentation rate is a reverse time presentation rate. Hence, both forward and reverse time presentations may be used thus allowing for a high degree of customisation and flexibility in the adjustment of presentation rates.

According to one embodiment of the invention, the method comprises the step of recording the content signal on a storage medium, and the step of receiving the content signal comprises receiving the recorded content signal from the storage medium, and the step of deriving the content indicator is performed in association with the step of recording the video signal. This provides for reduced computational resource requirements in cases where play back processing is more substantial than recording processing.

According to another embodiment of the invention, the step of deriving the content indicator comprises analysing content information data associated with the content signal. This provides the advantage of a low complexity content analysis with low computational resource requirements.

According to a different embodiment of the invention, the content signal is a video signal. Preferably, the content source is a video signal storage medium or a video broadcast source. Hence, the presentation or playback rate of video signals may be optimised for different content.

According to a different embodiment of the invention, the content signal is a multimedia signal. Hence, an improved system for presentation of multimedia signals wherein presentation rates can be optimised for different content is provided.

According to one embodiment of the invention, the content signal is a text signal. Hence, an improved system for presentation of text wherein presentation rates can be optimised for different content is provided.

According to another embodiment of the invention, the content signal is an audio signal. Hence, an improved system for presentation of audio signals wherein presentation rates can be optimised for different content is provided.

According to a second aspect of the invention, there is provided an apparatus for content presentation comprising: a receiver for receiving a content signal from a content source; a processor for deriving a content indicator from a content analysis of the content signal; and a controller for adjusting a presentation rate of the content signal in response to the content indicator. Preferably the apparatus is a video signal playback apparatus and the content signal is a video signal. According to a preferred feature the apparatus is a video recorder unit further comprising a recording controller operable to record the video signal on a storage medium.

These and other aspects of the invention will be apparent from and elucidated with reference to the embodiments described hereinafter.

### BRIEF DESCRIPTION OF THE DRAWINGS

An embodiment of the invention will be described, by way of example only, with reference to the drawings, in which

FIG. 1 is an illustration of a flow chart for method of content presentation in accordance with an embodiment of the Invention; and

FIG. 2 is an illustration of a video apparatus in accordance with an embodiment of the invention.

### DESCRIPTION OF PREFERRED EMBODIMENTS

An embodiment of the invention will in the following be described mainly with specific reference to video content signals but it will be apparent that the invention is not limited to this application and may be equally applicable to many other content signals including audio signals, text based information and multimedia content.

In accordance with a preferred embodiment of the invention, the presentation rate of a content signal is adjusted in response to a content indicator. The content indicator is derived from the content signal by a content analysis and in the preferred embodiment the content indicator is derived from the content signal in a real time continuous way such that the content indicator indicates the current content of the content signal.

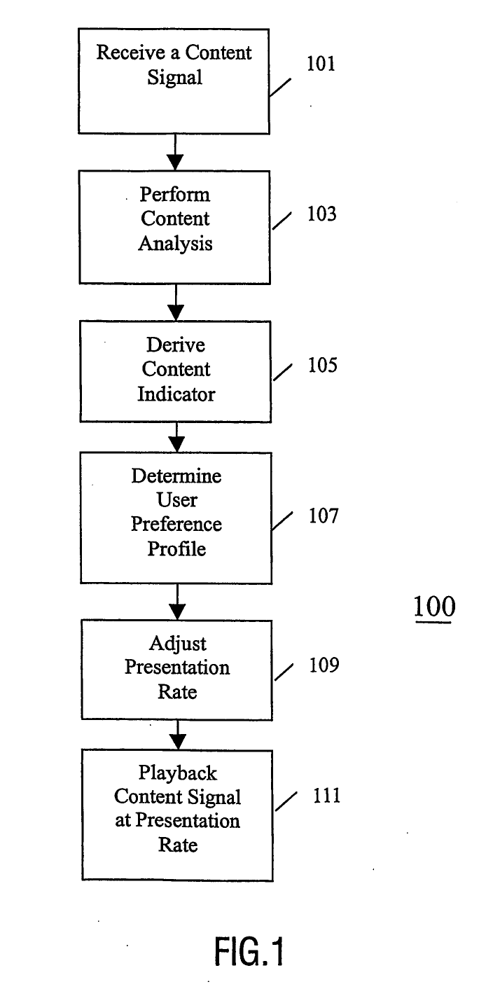

FIG. 1 is an illustration of a flow chart for a method 100 of content presentation in accordance with a preferred embodiment of the Invention.

In step 101 a content signal is received from a content source. The content signal and source may be any suitable signal and source. Thus specifically the source may be a suitable storage media for the content or may be a broadcast source transmitting the content signal to a plurality of users.

Step 101 is followed by step 103 wherein a content analysis is performed on the content signal to determine a content category of the current signal. Thus the signal is analysed, and it is in the preferred embodiment determined which content category; the currently received content belongs to. Any suitable method of content analysis may be used but in a simple embodiment the content signal may have associated (or embedded) meta-data which comprises information related to the current content of the content signal.

Step 103 is followed by step 105 wherein a content indicator is derived based on the content analysis. In a simple embodiment, the content indicator is simply a data value indicating which category of content the content signal currently belongs to.

Step 105 is followed by step 107 wherein a user preference profile is determined. The user preference profile comprises information related to the user's preference for different kinds of content. In a simple embodiment, the user preference profile is determined by the user manually inputting a user preference value for each content category that may be indicated by the content indicator.

Step 107 is followed by step 109 wherein a presentation rate of the content signal is adjusted in response to the content indicator. In a simple embodiment, the presentation rate is in this step simply set by selecting a presentation rate from a plurality of predetermined presentation rates according to the content indicator and the user preference profile. Specifically, the user preference profile may comprise a user set presentation rate for each of the possible content categories of the content indicator. The presentation rate is simply set as the presentation rate stored for the category corresponding to the determined value of the content indicator.

Step 109 is followed by step 111 wherein the content is played back to the user at the determined presentation rate. Any suitable means for presenting the content to the user may be used. Thus for a visual presentation a suitable display may be used.

In the following a more detailed description of a preferred embodiment wherein the content signal is a video content signal will be described but it will be apparent that the invention is not limited to this application.

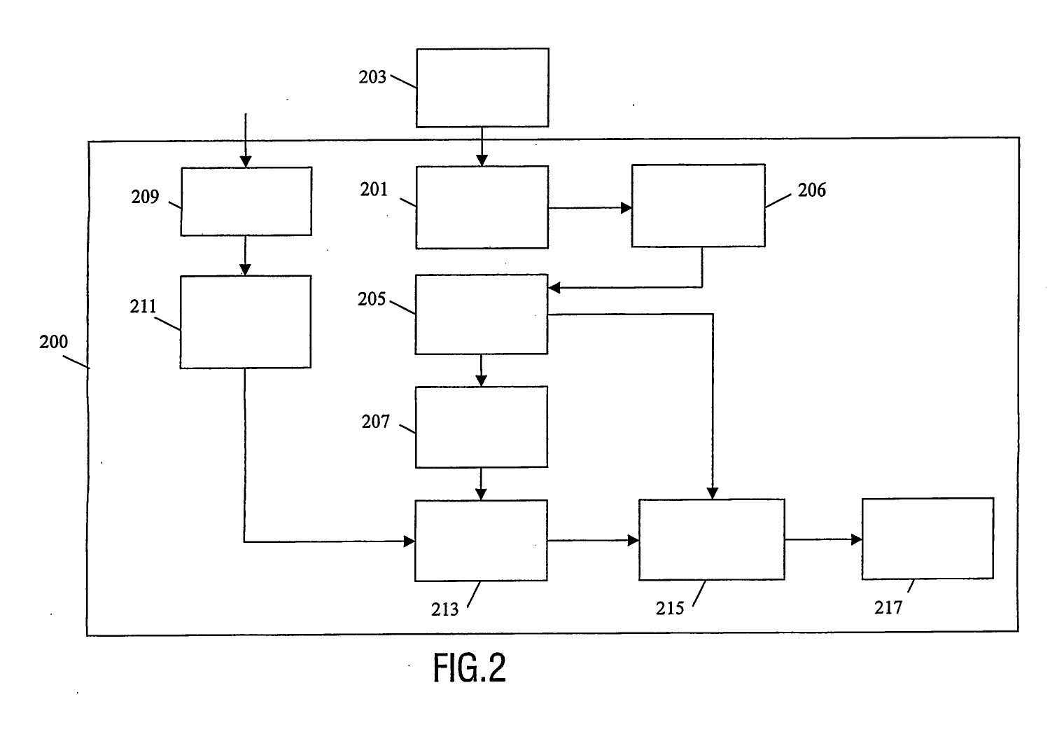

FIG. 2 is an illustration of a video apparatus 200 in accordance with a preferred embodiment of the invention. The video apparatus in the preferred embodiment is specifically a video recorder unit. In the current description, the reference to a video signal may further include a video signal with its associated audio signal.

The video apparatus 200 comprises a receiver 201 for receiving a content signal from a content source 203. In the preferred embodiment, the content source 203 is a TV broadcast transmitter which transmits a TV signal by way of radio transmissions, and the receiver 201 is a compatible TV video receiver as is well known in the art. In the preferred embodiment, the broadcast signal is a digital video signal compressed by an MPEG 2 compression scheme, and the receiver 201 is operable to receive such compressed digital video signals.

The receiver 201 is connected to a video storage memory 205 and the received video signal is stored in the video storage memory 205 under the control of a video apparatus controller (not shown). In the preferred embodiment, the user controls which TV programmes are recorded as is known in the art. Preferably, the digital MPEG-2 compressed video signal is stored in the video storage memory 205, which preferably is a hard disk of sufficient capacity. The storage is controlled by a recording controller 206 The video apparatus 200 further comprises a content analysis processor 207 for deriving a content indicator from a content analysis of the content signal. The content analysis processor 207 is connected to the video storage memory 205 and is operable to receive the signal from the video storage memory 205 and perform a content analysis on this signal.

It is within the contemplation of the invention that any suitable method of content analysis may be used. In the preferred embodiment, the content analysis simply comprises extracting meta-data from the video signal indicative of the current content of the video signal. Thus the broadcaster in this embodiment includes data related to the content of the video signal in the broadcast. The meta-data may either by embedded in the video signal itself or may be provided as a separate logical or physical channel. Specifically, the meta-data may provide content description in accordance with the Multimedia Content Description Interface, MPEG 7 as standardised by the Moving Pictures Expert Group.

In more advanced embodiments, the content analysis does not require the presence of dedicated content description but operates directly on the content signal itself. In recent years significant research has been carried out in the field of content analysis for e.g. video signals and any of the developed methods or algorithms for content analysis may be used without departing from the invention.

An example algorithm for content analysis is the detection of adverts in a TV broadcast. Typically, the broadcaster transmits the adverts at a louder audio volume than other programmes. Thus, an algorithm for detection of advert content comprises detecting an increased volume of for example voices and designating the content as adverts when such an increased volume level is detected.

As another example, during a football game, highlights may be detected from the associated audio signal. Specifically, the occurrence of a goal may be detected as an increase volume of the background noise from the spectators. Thus in this embodiment, the content analysis analyses the content of an individual programme (the football game) and divides this into content categories corresponding to highlights or goals and normal play.

Further information on content analysis is generally available to the person skilled in the art. For example, the articles “Content-Bases Multimedia Indexing and Retrieval” by C. Djeraba, IEEE Multimedia, April-June 2002, Institute of Electrical and Electronic Engineers; “A Survey on Content-Based Retrieval for Multimedia Databases” by A. Yoshika et al., IEEE Transactions on Knowledge and Data Engineering, vol. 11, No.1, January/February 1999, Institute of Electrical and Electronic Engineers; “Applications of Video-Content Analysis and Retrieval” by N. Dimitrova et al., IEEE Multimedia, July-September 2002, Institute of Electrical and Electronic Engineers and the therein included references provide an introduction to content analysis.

The content analysis thus provides content information. Hence, a content indicator related to the content of the signal is generated which either may be the direct result of the content analysis or may be the result of a post-processing of the results of the content analysis: In the preferred embodiment, the content indicator is simply a data value or control signal value which indicates which category of content from a predefined list of contents the current content belongs to. Preferably, the content analysis directly generates information corresponding to these categories but in some embodiments a further mapping between different categories may be included. In other embodiments, the content indicator may be a continuous value indicating for example the level of a specific characteristic in the content signal.

The video apparatus further comprises a user interface 209 connected to a user preference profile processor 211. The user preference profile processor 211 determines a preference profile for the user of the video apparatus 200. In the preferred embodiment, the user specifically inputs a preference for a set of video content categories through the user interface 209. Specifically, the user inputs a preferred playback rate for a set of predefined content categories such as sport, adverts, game shows, news, previews and other.

The user preference profile processor 211 is connected to a playback controller 213 as is the content analysis processor 207. The playback controller is operable to adjust a presentation (playback) rate of the content signal in response to the content indicator received from the content analysis processor 207. In the described preferred embodiment, the content indicator identifies one of a number of predetermined categories consistent with the categories of the user preference profile processor 211. Thus the playback controller 213 simply determines which category the content indicator refers to and selects the preferred playback rate of the preference distribution profile as entered by the user.

The playback controller 213 is connected to a playback video generator 215 which generates a playback video signal at the selected playback rate. The playback video generator 215 is connected to the video storage memory 205 for retrieving the stored video signal, and to a video display suitable for showing the generated video signal. Specifically, the playback video generator 215 may generate a signal suitable for a TV, and the video display 217 may be a TV external to the video apparatus.

The video apparatus 200 thus provides a system wherein a user may define presentation or playback rates for a number of different categories, and the playback controller 213 controls the playback rate accordingly. In the preferred embodiment, the playback controller adjusts the playback rate by selecting between a first presentation rate and at least a second presentation rate. For example, the user may have defined a real time playback rate for normal programmes and a fast forward rate for adverts. The video apparatus will accordingly continuously determine if the current content is a normal TV programme or an advert and switch the rates accordingly. Consequently, the user can watch conventional TV channels wherein the video apparatus automatically fast forwards through the commercials. In the preferred embodiment, the video apparatus can operate in different modes and specifically one of these modes correspond to normal viewing wherein the video signal is presented at real time, and at least one other mode comprises adjusting the playback rate according to the content of the signal.

As described above the content source is preferably a suitable video signal storage medium such as a video cassette tape, a hard disk or a DVD disc. However, in other embodiments the content source is a video broadcast source. In this embodiment, the video apparatus 200 may comprises a video signal buffer, and the broadcast signal may be transmitted at a higher than real time rate. Therefore the video signal buffer may be filled up during normal real time viewing and emptied during fast forward viewing. Preferably the video buffer has a size whereby it for the type of content and the available viewing rates will never or only rarely be completely full or fully emptied.

In some embodiments, at least one presentation rate is a reverse time presentation rate. Another presentation rate may be a substantially real time playback rate. In accordance with this embodiment, a user may for example reverse or fast reverse through a video signal with the video apparatus automatically detecting content of interest to the user and presenting this in a real time forward rate. For example, a user may fast reverse through a recorded football match with the video apparatus automatically detecting goals or other highlights and showing these in a normal forward direction. As a specific variant, a user may watch a football game in a normal forward real time rate. When a goal is scored the user may well wish to repeat the goal. In this case, he may press the fast reverse button whereafter the video apparatus will fast reverse. When the video apparatus in this reverse mode detects the goal being scored (e.g. from the associated audio), it will automatically revert back to normal play at the time of the goal or preferably at a predetermined time (e.g. 30 seconds) before the goal.

In the above described embodiment, the content analysis is performed during playback of the video signal. Additionally or alternatively, the content analysis and/or the derivation of the content indicator is performed in association with the step of recording the video signal. Hence, the content analysis may be performed during the recording stage, and the results of the content analysis and specifically the content indicator may be stored together with the video signal. This may provide a more efficient resource usage as the recording preferably comprises storing the received MPEG 2 digital signal directly with minimal processing, whereas the playback in some embodiments comprise generating a suitable analogue video signal from the digitally stored signal. This may in some embodiments require significant processing and by performing the content analysis during recording a more even computational resource demand is achieved between the recording and playback stage. Accordingly, the overall computational resource requirement is reduced and the cost of the video apparatus may be reduced.

Alternatively or additionally, the content analysis may be performed during idle periods of the video apparatus. Thus the content analysis may not be performed during either recording or playback but rather at times when none of these operations are performed. Although it is not guaranteed in this embodiment that a content indication is always available for all stored signals, it provides for a significantly reduced peak computational resource requirement.

The above description has focussed on a video application. However in other embodiments other content signals may be used.

In one embodiment, the content signal is a multimedia signal. The invention is thus equally applicable to content signals comprising different types of content in one signal.

In some embodiments, the content signal is a text signal. As a specific example, electronic books (e-book) are increasingly entering the consumer market. Typically, e-books comprise a display for displaying text and images, a processor controlling the operation of the e-book and a memory comprising the text and images. Typically, the memory may be removable to allow for the content to be replaced but in some e-books, a permanent memory is used with new content being downloaded to the e-book through a suitable interface. e-books are typically small portable devices, and for example many Personal Digital Assistants (PDAs) provide e-book functionality.

In one embodiment, the presentation of text on the e-book depends on the content of the text. Hence, the content signal comprising the text data retrieved from the memory is analysed and depending on the content a suitable presentation rate is selected. Any suitable method of content analysis may be used, but in the described embodiment the memory further comprises content information data. Hence, the content signal may comprise both the content information signal and the content data signal as read from the memory. Accordingly, a user may define preferred presentation rates for different types of text or images, and the e-book will present the data accordingly. Thus if a user is viewing for example an electronic newspaper, he may prefer that pages comprising for example adverts, comics and TV programmes should be skipped (such as fast forwarded), whereas articles should be presented at a normal rate. Specifically, the normal rate may require a user activation (e.g. pressing of a button) in order to turn to a new page, whereas the fast-forward or skip rate automatically turns the pages at short intervals or directly skips to the next article.

In other embodiments, the content signal is an audio signal.

In one such embodiment, an audio playback apparatus comprises a fast forward button, the activation of which causes a fast forwarding with a rate depending on the content. In the specific embodiment of the audio playback apparatus being an audio recorder, the recorder may comprise functionality for determining a content indicator indicating whether the signal played back is speech or music. This content analysis can easily be made based on the general volume level or other specific audio characteristics which differ between speech and music. An example of a algorithm for detecting a speech signal can be found in U.S. Pat. No. 5,878,391, “Device for indicating a probability that a received signal is a speech signal”, U.S. Philips Corporation, Inventor(s): ;Aarts, Ronaldus M.

If this audio recorder for example is used to record radio programmes, it may at play back have preferred presentation (playback) rates for music and speech. Thus, the user may achieve that a recorded radio programme is played back such that all speech is forwarded through thereby leaving only the music content. Depending on the user's preferences, he may alternatively choose to listen to all speech and forward through the music.

In another embodiment a compact disc player comprises a fast forward button which allows the user to fast forward through music until the content indicator corresponds to a preferred music category. The content analysis may in this embodiment divide the music into for example acoustic music (minimal low frequency rhythm), dance music (fast and high volume low frequency rhythm); slow music (slow rhythm), fast music (fast rhythm) etc. The user can select a preferred music style and accordingly the CD player may fast forward or even skip tracks corresponding to undesired music categories and only play the preferred category at normal rate.

The above description has focussed on the user selecting the preferred presentation rates. Any suitable means for inputting these preferences may be used including input from a keyboard or by voice using voice recognition. However, in the preferred embodiment of a video apparatus, the user input is with the aid of an on screen display wherein selected options and parameters can be selected through activation of a remote control.

In some embodiments, the presentation rate is not specifically (or not only) dependent on the user's preferences but may for example be predetermined or set in response to other suitable parameters.

In other embodiments, the user preferences are determined by other means than a user input. Generally any suitable method or algorithm for determining user preferences may be used. Specifically, the user preference profile may be determined in response to a previous user behaviour. In this embodiment, an appropriate content playback apparatus, such as the video apparatus previously described, monitors the user behaviour and sets the preferred presentation rates accordingly. Thus in the example of the video apparatus, it is monitored whenever the user at normal operation manually fast forwards through material and the user preference profile is set accordingly. As a specific example, the video apparatus will detect if a user typically fast forwards through adverts and if so will set the user preference profile such that adverts will be automatically fast forwarded.

It will be clear that in some embodiments, the user preference profile may not relate to a single user but to a plurality of users. This may for example be the case when a plurality of users use the same apparatus or when the user preference profile is advantageously determined for a suitable group of users.

The invention can be implemented in any suitable form including hardware, software, firmware or any combination of these. However, preferably, the invention is implemented as software programme running on one or more data processors. The functionality, elements and components may be implemented in a single unit, in a plurality of units or as part of other functional units.

Although the present invention has been described in connection with the preferred embodiment, it is not intended to be limited to the specific form set forth herein. Rather, the scope of the present invention is limited only by the accompanying claims.

The invention can be summarised as follows:

The invention relates to a system for content presentation of content signals such as video signals. A content presentation apparatus comprises a content signal receiver (201) receiving a content signal from a content source (203). The signal is stored in a memory (205). The memory is connected to a content analyser (207) which analyses the content and determines to which category of content this belongs. The apparatus further comprises a user preference profile processor (211) which determines a preferred presentation rate for different categories of content in response to a user input or a previous user behaviour. A playback controller (213) controls the playback of the content by setting the presentation rate to the preferred presentation rate of the user preference profile for the content category identified. Specifically, the invention provides for e.g. a fast forward button which fast forwards through unwanted content but plays at normal rate during user preferred content.

1. A method of content presentation comprising the steps of:
receiving a content signal from a content source;
deriving a content indicator from a content analysis of the content signal; and
adjusting a presentation rate of the content signal in response to the content indicator.

2. A method as claimed in claim 1 wherein step of adjusting further comprises adjusting the presentation rate in response to a user preference profile.

3. A method as claimed in claim 2 wherein the user preference profile is determined in response to a previous user behaviour.

4. A method as claimed in claim 2 wherein the user preference profile is determined in response to a user input.

5. A method as claimed in claim 1 wherein the step of adjusting the presentation rate comprises selection between a first presentation rate and at least a second presentation rate.

6. A method as claimed in claim 5 wherein the first presentation rate is a fast forward rate and the second presentation rate is a substantially real time presentation rate.

7. A method as claimed in claim 5 wherein at least one presentation rate is a reverse time presentation rate.

8. A method as claimed in claim 1 further comprising the step of recording the content signal on a storage medium, and wherein the step of receiving the content signal comprises receiving the recorded content signal from the storage medium, and the step of deriving the content indicator is performed in association with the step of recording the video signal.

9. A method as claimed in claim 1 wherein the step of deriving the content indicator comprises analysing content information data associated with the content signal.

10. A method of content presentation as claimed in claim 1 wherein the content signal is a video signal.

11. A method as claimed in claim 10 wherein the content source is a video signal storage medium.

12. A method as claimed in claim 11 wherein the content source is a video broadcast source.

13. A method as claimed in claim 1 wherein the content signal is a multimedia signal.

14. A method as claimed in claim 1 wherein the content signal is a text signal.

15. A method as claimed in claim 1 wherein the content signal is an audio signal.

16. A computer programme enabling the carrying out of a method according to claim 1.

17. An apparatus for content presentation comprising:
a receiver for receiving a content signal from a content source;
a processor for deriving a content indicator from a content analysis of the content signal; and
a controller for adjusting a presentation rate of the content signal in response to the content indicator.

18. An apparatus as claimed in claim 17 wherein the apparatus is a video signal playback apparatus and the content signal is a video signal.

19. An apparatus as claimed in claim 18 wherein the apparatus is a video recorder unit further comprising a recording controller operable to record the video signal on a storage medium.
